(19) United States
(12) Patent Application Publication
(10) Pub. No.: US 2020/0071528 A1
(43) Pub. Date: Mar. 5, 2020

(54) NANOSTRUCTURED THERMOPLASTIC POLYAMIDE-GRAFTED POLYOLEFIN COMPOSITION

(71) Applicant: Arkema France, Colombes (FR)

(72) Inventors: Mathieu SABARD, Serquiny (FR); Stéphane BIZAT, Barc (FR); Jean-Jacques FLAT, Goupillieres (FR); Grégoire AUSSEDAT, Paris (FR)

(73) Assignee: Arkema France, Colombes (FR)

(21) Appl. No.: 16/573,081

(22) Filed: Sep. 17, 2019

Related U.S. Application Data
(63) Continuation of application No. 14/897,011, filed on Dec. 9, 2015, now abandoned.

(30) Foreign Application Priority Data
Jun. 11, 2013 (FR) 1355386

(51) Int. Cl. C08L 87/00; B32B 27/22; B32B 27/32; B32B 27/34; C08L 23/04; C08L 77/06; C08L 77/00; C08L 23/12; C08L 77/02

(52) U.S. Cl. CPC C08L 87/005; C08L 2205/03; B32B 27/32; B32B 27/34; C08L 23/04; C08L 77/06; C08L 77/00; C08L 23/12; C08L 77/02; B32B 2307/718; B32B 2270/00; B32B 2307/71; B32B 2307/3065; C08L 2205/02; C08L 2205/025; B32B 27/22

(57) ABSTRACT

A composition including at least two grafted copolymers having a polyolefin basic polymer chain and polyamide grafts, the polyamide grafts being 5 wt % and 35 wt % of the composition bonded to the first and second copolymer as well as a third component selected among certain polyamides, polyethylenes or polypropylenes or a mixture thereof. Also, a multilayer structure including a plurality of adjacent layers, at least one of which is the aforementioned composition.

### CROSS REFERENCE TO RELATED APPLICATIONS

The present application is a continuation of U.S. application Ser. No. 14/897,011, filed on Dec. 9, 2015, which is a U.S. national stage of International Application No. PCT/FR2014/051357, filed on Jun. 6, 2014, which claims the benefit of French Application No. 1355386, filed on Jun. 11, 2013. The entire contents of each of U.S. application Ser. No. 14/897,011, International Application No. PCT/FR2014/051357 and French Application No. 1355386 are hereby incorporated herein by reference in their entirety.

### TECHNICAL FIELD

A subject of the invention is a nanostructured thermoplastic composition preferably comprising a mixture of at least one ethylene-based terpolymer and an elastomeric copolymer also based on ethylene, this terpolymer and this elastomeric copolymer each having a not inconsiderable amount of a particular type of graft, and a particular component selected from certain polyamides, polyethylenes or polypropylenes, or a mixture thereof.

The invention also relates to a multilayer structure in which at least one of the layers consists of the composition according to the invention.

### BACKGROUND

Document WO 02/28959 describes a graft copolymer with polyamide blocks on a polyolefin backbone which is chosen from ethylene/maleic anhydride and ethylene/alkyl (meth)acrylate/maleic anhydride copolymers, forming a nanostructured co-continuous blend. This gives this copolymer, inter alia, exceptional low-temperature impact resistance that is maintained when this graft copolymer is redispersed in flexible polyolefins such as flexible ethylene polymers.

Such mixtures are used as adhesives, films, tarpaulins, calendered products, electrical cables or powders for slush molding processes. In document WO 2006/085007, such a composition was used to form a heat protection layer for a substrate subjected to temperatures of greater than 150° Celsius (° C.).

These materials, referred to as nanostructured, as defined in the two abovementioned patent documents, are very flexible (flexural modulus <200 MPa).

In some very specific cases, polyamides have been added to thermoplastic compositions, but the impact resistance of this mixture of copolymers grafted with such polyamides proves insufficient, in particular when the temperatures are low: resilience at −20° C. is of the order of 15 kJ/m² (kilojoule per meter squared), which makes them inappropriate for certain applications such as, for example, applications in sports at low temperatures (ski boots for example).

Moreover, irrespective of the addition which could be envisioned to these compounds, it is imperative that the composition retains a sufficiently high flexural modulus (ideally >400 MPa) and a low level of viscosity.

Now, those skilled in the art know that, for thermoplastic compositions, improving the impact resistance is inevitably carried out to the detriment of the flexural modulus, or even the viscosity.

### SUMMARY

After various experiments and modifications, it has been observed by the applicant that, contrary to the teaching well known to those skilled in the art, a nanostructured co-continuous composition comprising determined amounts of a particular polymer, a first copolymer and a second elastomeric copolymer, these two latter components being grafted by a polyamide in a certain percentage range by weight of the composition, has very considerably improved impact resistance while still retaining a stable flexural modulus, that is to say without deterioration.

Thus, the present invention relates to a thermoplastic composition comprising:
a first copolymer grafted by polyamide grafts and consisting of a polyolefin backbone containing a residue of at least one unsaturated monomer (X) and a plurality of polyamide grafts, the polyamide grafts are attached to the polyolefin backbone by the residue of the unsaturated monomer (X) comprising a function capable of reacting by a condensation reaction with a polyamide having at least one amine end group and/or at least one carboxylic acid end group, the residue of the unsaturated monomer (X) is fixed to the backbone by grafting or copolymerization;

characterized in that it comprises:
a second copolymer consisting of an elastomeric copolymer grafted by polyamide grafts and consisting of a polyolefin backbone selected from a maleicized ethylene-propylene copolymer, a maleicized ethylene-butene copolymer, a maleicized ethylene-hexene copolymer, a maleicized ethylene-octene copolymer, a maleicized ethylene-methyl acrylate copolymer, an ethylene-propylene-diene copolymer and a plurality of polyamide grafts;
a third component consisting of a polyamide, a polyethene or a polypropylene, or a mixture thereof;

and in that the following weight ratios are satisfied:
between 10% and 30% by weight of the composition for the polyolefin backbone of the abovementioned first copolymer,
between 10% and 30% by weight of the composition for the polyolefin backbone of the abovementioned second copolymer,
between 5% and 35% by weight of the composition of polyamide grafts, fixed to the first and second copolymer,
between 30% and 60% by weight of the above-mentioned third component.

Other advantageous features of the invention are specified hereinbelow:

Preferably, the unsaturated monomer (X) is maleic anhydride.

Advantageously, the first copolymer is an ethylene/alkyl (meth)acrylate/maleic anhydride terpolymer.

According to a particular aspect of the invention, the abovementioned grafted polymer is advantageously nanostructured.

According to one aspect of the invention, the number-average molar mass of the abovementioned polyamide grafts of the abovementioned grafted polymer is within the range from 1000 to 10 000 g/mol, preferably between 1000 and 5000 g/mol.

Preferably, the polyamide grafts consist of monofunctional-NH₂-terminated polyamide PA-6 grafts.

Advantageously, the polyamide of the third component consists of a polyamide 6, a polyamide 11, polyamide 12, polyamide 6,6, polyamide 6,9, polyamide 6,10, polyamide 6,12, polyamide 10,12, polyamide 10,10, polyamide 12,12, semiaromatic polyamide, especially MXD,6, polyphthalamides obtained from terephthalic and/or isophthalic acid, and their copolyamides.

According to an advantageous aspect of the invention, the abovementioned first copolymer and the abovementioned second copolymer represent a maximum of 50% by weight of the composition.

Advantageously, the functional adjuvant consists of a plasticizer, an adhesion promoter, a UV stabilizer and/or a UV absorber, an antioxidant, a flame retardant, and/or a dyeing/whitening agent.

According to one possibility afforded by the invention, the composition consists solely of the first and the second of the abovementioned grafted copolymers and the abovementioned third component.

The invention also relates to a multilayer structure comprising a plurality of adjacent layers, characterized in that at least one of these layers consists of the composition as defined above.

It should be noted that the composition according to the invention is presented in connection with applications in sport (because of the necessary impact resistance, in particular at low temperatures) but, of course, this composition may be envisaged for all other applications in which such a composition is advantageously useable, in particular in multilayer structures such as, for example, skis, adhesive coatings or films, or air or fluid transport pipes.

### DETAILED DESCRIPTION

The polyolefin backbone of the first grafted polymer is a polymer which comprises, as monomer, an α-olefin.

α-Olefins having from 2 to 30 carbon atoms are preferred.

By way of α-olefin, mention may be made of ethylene, propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, 1-docosene, 1-tetracosene, 1-hexacosene, 1-octacosene, and 1-triacontene.

Mention may also be made of the cycloolefins having from 3 to 30 carbon atoms, preferably from 3 to 20 carbon atoms, such as cyclopentane, cycloheptene, norbornene, 5-methyl-2-norbornene, tetracyclododecene, and 2-methyl-1,4,5,8-dimethano-1,2,3,4,4a,5,8,8a-octahydronaphthalene; diolefins and polyolefins, such as butadiene, isoprene, 4-methyl-1,3-pentadiene, 1,4-pentadiene, 1,5-hexadiene, 1,3-hexadiene, 1,3-octadiene, 1,4-octadiene, 1,5-octadiene, 1,6-octadiene, ethylidene norbornene, vinyl norbornene, dicyclopentadiene, 7-methyl-1,6-octadiene, 4-ethylidene-8-methyl-1,7-nonadiene, and 5,9-dimethyl-1,4,8-decatriene; aromatic vinyl compounds such as mono- or polyalkylstyrenes (comprising styrene, o-methylstyrene, m-methylstyrene, p-methylstyrene, o,p-dimethylstyrene, o-ethylstyrene, m-ethylstyrene and p-ethylstyrene), and derivatives comprising functional groups such as methoxystyrene, ethoxystyrene, vinylbenzoic acid, methyl vinylbenzoate, vinylbenzyl acetate, hydroxystyrene, o-chlorostyrene, p-chlorostyrene, divinylbenzene, 3-phenylpropene, 4-phenylpropene, α-methylstyrene, vinyl chloride, 1,2-difluoroethylene, 1,2-dichloroethylene, tetrafluoroethylene, and 3,3,3-trifluoro-1-propene.

Within the context of the present invention, the term α-olefin also comprises styrene. As α-olefin, propylene is preferred and most especially ethylene.

This polyolefin may be a homopolymer when just one α-olefin is polymerized in the polymer chain. By way of example, mention may be made of polyethylene (PE) or polypropylene (PP).

This polyolefin may also be a copolymer when at least two comonomers are copolymerized in the polymer chain, one of the two comonomers, referred to as “first comonomer”, being an α-olefin and the other comonomer, referred to as “second comonomer”, is a monomer capable of polymerizing with the first monomer.

By way of second comonomer, mention may be made of:
one of the α-olefins already mentioned, the latter being different from the first α-olefin comonomer,
dienes such as, for example, 1,4-hexadiene, ethylidene norbornene, butadiene,
unsaturated carboxylic acid esters, such as, for example, alkyl acrylates or alkyl methacrylates, grouped together under the term alkyl (meth)acrylates. The alkyl chains of these (meth)acrylates may have up to 30 carbon atoms. As alkyl chains, mention may be made of methyl, ethyl, le propyl, n-butyl, sec-butyl, isobutyl, tert-butyl, pentyl, hexyl, heptyl, octyl, 2-ethylhexyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl. Methyl, ethyl and butyl (meth)acrylates are preferred as esters of unsaturated carboxylic acids,
vinyl esters of carboxylic acids. By way of example of vinyl esters of carboxylic acid, mention may be made of vinyl acetate, vinyl versatate, vinyl propionate, vinyl butyrate or vinyl maleate. Vinyl acetate is preferred as vinyl ester of carboxylic acid.

Advantageously, the polyolefin backbone comprises at least 50 mol % of the first comonomer; the density thereof may advantageously be between 0.91 and 0.96.

The preferred polyolefin backbones consist of an ethylene—alkyl (meth)acrylate copolymer. By using this polyolefin backbone, excellent resistance to aging, light and temperature is obtained.

If different “second comonomers” were copolymerized in the polyolefin backbone, this would not constitute a departure from the scope of the invention.

According to the present invention, the polyolefin backbone contains at least one residue of an unsaturated monomer (X) which may react with an acid and/or amine function of the polyamide graft in a condensation reaction. According to the definition of the invention, the unsaturated monomer (X) is not a “second comonomer”.

As unsaturated monomer (X) included on the polyolefin backbone, mention may be made of:
unsaturated epoxides. Among these they are, for example, aliphatic glycidyl esters and ethers such as allyl glycidyl ether, vinyl glycidyl ether, glycidyl maleate and glycidyl itaconate, glycidyl acrylate and glycidyl methacrylate. They are also, for example, alicyclic glycidyl esters and ethers such as 2-cyclohexene-1-glycidyl ether, glycidyl cyclohexene-4,5-dicarboxylate, glycidyl cyclohexene-4-carboxylate, glycidyl 5-norbornene-2-methyl-2-carboxylate and diglycidyl endo-cis-bicyclo[2.2.1]-5-heptene-2,3-dicarboxylate.

As unsaturated epoxide, glycidyl methacrylate is preferably used,
unsaturated carboxylic acids and their salts, for example acrylic acid or methacrylic acid and the salts of these same acids,
carboxylic acid anhydrides. They may be chosen, for example, from maleic, itaconic, citraconic, allylsuccinic, cyclohex-4-ene-1,2-dicarboxylic, 4-methylenecyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides. As carboxylic acid anhydride, maleic anhydride is preferably used.

The unsaturated monomer (X) is preferably an unsaturated carboxylic acid anhydride.

According to one advantageous version of the invention, the average preferred number of unsaturated monomer (X) fixed to the polyolefin backbone is greater than or equal to 1.3 and/or preferably less than or equal to 20.

Thus, if (X) is maleic anhydride and the number-average molar mass of the polyolefin is 15 000 g/mol, it has been found that this corresponds to a proportion of anhydride of at least 0.8%, and at most 6.5%, by weight of the whole polyolefin backbone. These values, combined with the mass of the polyamide grafts, determine the proportion of polyamide and of backbone in the polyamide-grafted polymer.

The polyolefin backbone containing the residue of the unsaturated monomer (X) is obtained by polymerization of the monomers (first comonomer, optional second comonomer, and optionally unsaturated monomer (X)). This polymerization can be carried out by a high-pressure radical process or a process in solution, in an autoclave or tubular reactor, these processes and reactors being well known to those skilled in the art. When the unsaturated monomer (X) is not copolymerized in the polyolefin backbone, it is grafted to the polyolefin backbone. The grafting is also an operation that is known per se. The composition would be in accordance with the invention if several different functional monomers (X) were copolymerized with and/or grafted to the polyolefin backbone.

Depending on the types and ratio of monomers, the polyolefin backbone may be semicrystalline or amorphous. In the case of amorphous polyolefins, only the glass transition temperature is observed, whereas in the case of semicrystalline polyolefins a glass transition temperature and a melting temperature (which will inevitably be higher) are observed. A person skilled in the art will only have to select the ratios of monomer and the molecular weights of the polyolefin backbone in order to be able to easily obtain the desired values of the glass transition temperature, optionally of the melting temperature, and also of the viscosity of the polyolefin backbone.

Preferably, the polyolefin has a Melt Flow Index (MFI) of between 3 and 400 g/10 min (190° C., 2.16 kg, ASTM D 1238).

The polyolefin backbone of the second grafted copolymer is chosen from a limited list, namely from a maleicized ethylene-propylene copolymer, a maleicized ethylene-butene copolymer, a maleicized ethylene-hexene copolymer, a maleicized ethylene-octene copolymer, a maleicized ethylene-methylcrylate copolymer and an ethylene-propylene-diene copolymer.

With regard to the abovementioned first or second grafted polymer, between 5% and 35% by weight of polyamide grafts will be used, in consideration of the sum of the polyamide grafts for the two grafted polymers. These polyamide grafts are grafted in the conventional way, according to one of the techniques well known to those skilled in the art, either to the maleic anhydride of the first copolymer or to the functional monomer of the second copolymer (the monomer other than ethylene).

The polyamide grafts, whether present on the first copolymer or the second copolymer, may be either homopolyamides or copolyamides.

Aliphatic homopolyamides resulting from the polycondensation:
of a lactam,
or of an aliphatic α,ω-aminocarboxylic acid,
or of an aliphatic diamine and an aliphatic diacid are particularly targeted by the expression “polyamide grafts”.

As examples of a lactam, mention may be made of caprolactam, oenantholactam and lauryllactam.

As examples of an aliphatic α,ω-aminocarboxylic acid, mention may be made of aminocaproic acid, 7-aminoheptanoic acid, 11-aminoundecanoic acid and 12-aminododecanoic acid.

As examples of an aliphatic diamine, mention may be made of hexamethylenediamine, dodecamethylenediamine and trimethylhexamethylenediamine.

As examples of an aliphatic diacid, mention may be made of adipic, azelaic, suberic, sebacic and dodecanedicarboxylic acids.

Among the aliphatic homopolyamides, mention may be made, by way of example and nonlimitingly, of the following polyamides: polycaprolactam (PA-6); polyundecanamide (PA-11, sold by Arkema under the brand Rilsan®); polylauryllactam (PA-12, also sold by Arkema under the brand Rilsan®); polybutylene adipamide (PA-4,6); polyhexamethylene adipamide (PA-6,6); polyhexamethylene azelamide (PA-6,9); polyhexamethylene sebacamide (PA-6,10); polyhexamethylene dodecanamide (PA-6,12); polydecamethylene dodecanamide (PA-10,12); polydecamethylene sebacamide (PA-10,10) and polydodecamethylene dodecanamide (PA-12,12).

The expression “semicrystalline polyamides” also targets cycloaliphatic homopolyamides.

Mention may especially be made of the cycloaliphatic homopolyamides that result from the condensation of a cycloaliphatic diamine and an aliphatic diacid.

As an example of a cycloaliphatic diamine, mention may be made of 4,4′-methylenebis(cyclohexylamine), also known as para-bis(aminocyclohexyl)methane or PACM, 2,2′-dimethyl-4,4′-methylenebis(cyclohexylamine), also known as bis(3-methyl-4-aminocyclohexyl)methane or BMACM.

Thus, among the cycloaliphatic homopolyamides, mention may be made of the polyamides PACM,12 resulting from the condensation of PACM with the C12 diacid, BMACM,10 and BMACM,12 resulting from the condensation of BMACM with, respectively, C10 and C12 aliphatic diacids.

The expression “polyamide grafts” also targets the semiaromatic homopolyamides that result from the condensation:
of an aliphatic diamine and an aromatic diacid, such as terephthalic acid (T) and isophthalic acid (I). The polyamides obtained are then commonly known as “polyphthalamides” or PPAs; and;
of an aromatic diamine, such as xylylenediamine, and more particularly meta-xylylenediamine (MXD) and an aliphatic diacid.

Thus, nonlimitingly, mention may be made of the polyamides 6,T, 6,I, MXD,6 or else MXD,10.

The polyamide grafts used in the composition according to the invention are preferably copolyamides. The latter result from the polycondensation of at least two of the groups of monitors presented above for obtaining homopolyamides. The term “monomer” in the present description of the copolyamides must be understood in the sense of “repeating unit”. Indeed, the case in which one repeating unit of PA consists of the combination of a diacid and a diamine, is characteristic. It is considered that the combination of a diamine and a diacid, that is to say the diamine-diacid pair (in equimolar amounts), corresponds to the monomer. This is explained by the fact that, individually, the diacid or the diamine is only a structural unit and on its own is insufficient to undergo polymerization to give a polyamide.

Thus copolyamides cover in particular the condensation products:
of at least two lactams,
of at least two aliphatic α,ω-aminocarboxylic acids,
of at least one lactam and at least one aliphatic α,ω-aminocarboxylic acid,
of at least two diamines and at least two diacids,
of at least one lactam with at least one diamine and at least one diacid,
of at least one aliphatic α,ω-aminocarboxylic acid with at least one diamine and at least one diacid,

the diamine(s) and the diacid(s) possibly being, independently of one another, aliphatic, cycloaliphatic or aromatic.

Depending on the types and ratio of monomers, the copolyamides may be semicrystalline or amorphous. In the case of amorphous copolyamides, only the glass transition temperature is observed, whereas in the case of semicrystalline copolyamides, a glass transition temperature and a melting temperature (which will inevitably be higher) are observed.

Among the amorphous copolyamides that can be used within the context of the invention, mention may be made, for example, of the copolyamides containing semiaromatic monomers.

Among the copolyamides, it is also possible to use semicrystalline copolyamides and particularly those of the PA-6/11, PA-6/12 and PA-6/11/12 type.

The degree of polymerization may vary to a large extent; depending on its value it is a polyamide or a polyamide oligomer.

Advantageously, the polyamide grafts are monofunctional.

So that the polyamide graft has a monoamine end group, it is sufficient to use a chain limiter of formula:

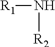

in which:
R1 is hydrogen or a linear or branched alkyl group containing up to 20 carbon atoms; and
R2 is a linear or branched alkyl or alkenyl group having up to 20 carbon atoms, a saturated or unsaturated cycloaliphatic radical, an aromatic radical or a combination of the preceding. The limiter may be, for example, laurylamine or oleylamine.

So that the polyamide graft has a monocarboxylic acid end group, it is sufficient to use a chain limiter of formula R′₁—COOH, R′₁—CO—O—CO—R′₂ or a dicarboxylic acid.

R′₁ and R′₂ are linear or branched alkyl groups containing up to 20 carbon atoms.

Advantageously, the polyamide graft has one end group having an amine functionality. The preferred monofunctional polymerization limiters are laurylamine and oleylamine.

The polyamide grafts have a molar mass of between 1000 and 10 000 g/mol and preferably between 1000 and 5000 g/mol.

The polycondensation may be used to graft the polyamide grafts, and it is carried out according to the conventionally known processes, for example at a temperature of generally between 200 and 300° C., under vacuum or under an inert atmosphere, with stirring of the reaction mixture. The average chain length of the graft is determined by the initial molar ratio between the polycondensable monomer or the lactam and the monofunctional polymerization limiter. For the calculation of the average chain length, one chain limiter molecule is usually counted per one graft chain.

A person skilled in the art will only have to select the types and ratio of monomers and also choose the molar masses of the polyamide grafts in order to be able to easily obtain the desired values of the glass transition temperature, optionally of the melting temperature and also of the viscosity of the polyamide graft.

The condensation reaction of the polyamide graft on the polyolefin backbone (first or second copolymer) containing the residue of X (or the functionalized monomer for the second grafted copolymer, namely the elastomeric copolymer) is carried out by reaction of one amine or acid function of the polyamide graft with the residue of X. Advantageously, monoamine polyamide grafts are used and amide or imide bonds are created by reacting the amine function with the function of the residue of X.

This condensation is preferably carried out in the melt state. To manufacture the composition according to the invention, it is possible to use conventional kneading and/or extrusion techniques. The components of the composition are thus blended to form a compound which may optionally be granulated on exiting the die. Advantageously, coupling agents are added during the compounding.

To obtain a nanostructured composition, it is thus possible to mix the polyamide graft and the backbone in an extruder, at a temperature generally between 200° C. and 300° C. The average residence time of the molten material in the extruder may be between 5 seconds and 5 minutes, and preferably between 20 seconds and 1 minute. The efficiency of this condensation reaction is evaluated by selective extraction of free polyamide grafts, that is to say those that have not reacted to form the polyamide-grafted polymer.

The preparation of polyamide grafts having an amine end group and also their addition to a polyolefin backbone containing the residue of (X) or of a functionalized monomer (second copolymer) is described in U.S. Pat. Nos. 3,976,720, 3,963,799, 5,342,886 and FR 2291225. The polyamide-grafted polymer of the present invention advantageously has a nanostructured organization.

The composition according to the invention also comprises a third component, namely a high molecular weight polyamide chosen from polyamide 6, polyamide 11, polyamide 12, polyamide 6,6, polyamide 6,9, polyamide 6,10, polyamide 6,12, polyamide 10,12, polyamide 10,10, polyamide 12,12, semiaromatic polyamides, especially MXD,6, polyphthalamides obtained from terephthalic and/or isophthalic acid, and the copolyamides thereof, a polyethylene (VLDPE, LDPE, LLDPE, MDPE, HDPE, etc.) and/or a polypropylene (homopolymer or copolymer). In the remainder of this text, and in particular in the examples of tests carried out on the composition, the component polyamide 6 has always been used, but the applicant also carried out these same tests conclusively for the other polyamides cited and claimed as well as for the polyethylenes and polypropylenes, alone or in a mixture.

Plasticizers could be added to the composition according to the invention in order to facilitate processing and improve the productivity of the process for manufacturing the composition and the structures. Mention will be made, as examples, of paraffinic, aromatic or naphthalenic mineral oils which also make it possible to improve the adhesive strength of the composition according to the invention. Mention may also be made, as plasticizer, of phthalates, azelates, adipates, and tricresyl phosphate.

Similarly, adhesion promoters, although not necessary, may advantageously be added in order to improve the adhesive strength of the composition when this adhesive strength must be particularly high. The adhesion promoter is a non-polymeric ingredient; it may be organic, crystalline, mineral and more preferably semi-mineral semi-organic. Among the latter, mention may be made of organic titanates or silanes, such as for example monoalkyl titanates, trichlorosilanes and trialkoxysilanes. It is also possible to provide for these adhesion promoters to be directly grafted to the first or the second copolymer by a technique well known to those skilled in the art, for example via reactive extrusion.

Since UV radiation is capable of resulting in a slight yellowing of the thermoplastic compositions, UV stabilizers and UV absorbers (these compounds being generally referred to as anti-UV agents), such as benzotriazole, benzophenone and other hindered amines, may be added in certain applications in which such a phenomenon is to be avoided. These compounds may be, for example, based on benzophenone or benzotriazole. They can be added in amounts of less than 10%, and preferably of from 0.1% to 5%, by weight of the total weight of the composition.

Antioxidants could also be added in order to limit yellowing during the manufacture of the composition, such as phosphorus-containing compounds (phosphonites and/or phosphites) and hindered phenolics. These antioxidants can be added in amounts of less than 10%, and preferably of from 0.1% to 5%, by weight of the total weight of the composition.

Similarly, in certain applications, flame retardants may also be added to the composition according to the invention. These flame retardants may be halogenated or non-halogenated. Among the halogenated flame retardants, mention may be made of brominated products. Use may also be made, as non-halogenated flame retardants, of additives based on phosphorus such as ammonium polyphosphate, aluminum phosphinates or phosphonates, melamine cyanurate, pentaerythritol, zeolites and also mixtures of these agents. The composition may comprise these agents in proportions ranging from 3% to 40% relative to the total weight of the composition. It is also possible to add dyeing or whitening compounds.

It is also possible to add pigments to the composition, such as for example dyeing or whitening compounds, in proportions generally ranging from 5% to 15% relative to the total weight of the composition.

### Example

As has been mentioned above, the technique of grafting polyamide grafts to the polyolefin backbone in order to obtain the polyamide-grafted polyolefin according to the invention is well known to those skilled in the art, and especially from the documents cited above FR 2912150, FR 2918150 or EP 2 196 489.

It is not therefore outside the scope of the invention if crosslinking agents are added. As examples, mention may be made of isocyanates or organic peroxides. This crosslinking may also be carried out by known irradiation techniques. This crosslinking may be carried out by one of numerous methods known to those skilled in the art, especially by the use of heat-activated initiators, for example peroxides and azo compounds, photoinitiators such as benzophenone, by radiation techniques comprising light rays, UV rays, electron beams and X-rays, silanes bearing reactive functions such as an aminosilane, an epoxysilane, a vinylsilane such as for example vinyltriethoxysilane or vinyltrimethoxysilane, and moisture crosslinking. The manual entitled “Handbook of polymer foams and technology” above, pages 198 to 204, provides additional information to which those skilled in the art may refer.

Materials Used to Form the Formulations Tested:

Lotader® 5500: terpolymer of ethylene, ethyl acrylate (15.5% by weight) and maleic anhydride (2.8% by weight) produced by Arkema, with an MFI (190° C. under 2.16 kg measured according to ISO 1133) of 20 g/10 min;

Lotader® 4210: terpolymer of ethylene, ethyl acrylate (6.5% by weight) and maleic anhydride (3.6% by weight) produced by Arkena, with an MFI (190° C. under 2.16 kg measured according to ISO 1133) of 9 g/10 min;

Maleicized EPR (“Ethylene Propylene Rubber”) Exxelor VA 1803: sold by Exxon.

Polyamide prepolymer: Mono-NH₂-terminated polyamide 6 prepolymer, Mₙ 2500 g/mol, produced by the applicant. This prepolymer was synthesized by polycondensation from 6-lactam. Laurylamine is used as a chain limiter so as to have only one primary amine function at the end of the chain. The number-average molar mass of the prepolymer is 2500 g/mol.

High molecular mass polyamide 6, of Mn=15 000 g/mol, sold by Domo Chemicals under the reference Domamid 24, having a relative viscosity in solution of 2.45 according to the ISO 307 standard.

Apolhya®: The Apolhya family is a family of polymers sold by Arkema which combine the properties of polyamides with those of polyolefins by virtue of co-continuous morphologies being obtained on the nanometer scale. It is a blend composed of Lotader® and mono-NH₂-terminated polyamide 6 prepolymer, for example Lotader® 5500 and mono-NH₂-terminated PA-6 prepolymer with a molar mass of 2500 g/mol.

Obtaining the Formulations Tested:

Essentially, three types of compositions were prepared to carry out the tests, namely a composition of Apolhya® type, hereinafter referred to as “composition no. 1”, compositions consisting of mixtures of Lotader®, prepolymer PA-6 and high molecular mass polyamide 6, hereinafter referred to as “compositions no. 2 to no. 5”, and a plurality of compositions consisting of a mixture of EPR VA 1803, Lotader®, prepolymer PA-6, and high molecular mass polyamide 6 referred to hereinafter as “compositions no. 6 to no. 18”.

| | Lotader ® | EPR VA 1803 | Polyamide grafts |
|---|---|---|---|
| Composition | (% by weight of | (% by weight of | (% by weight of |
| no. | the composition) | the composition) | the composition) |
| 1 | 75 | — | 25 |
| (Apolhya) | (Lotader 5500) | | |
| 2 | 30 | — | 70 |
| | (Lotader 5500) | | (of which 30% |
| | | | prepolymer and |
| | | | 40% high mass) |
| 3 | 30 | — | 70 |
| | (Lotader 4210) | | (of which 30% |
| | | | prepolymer and |
| | | | 40% high mass) |
| 4 | 30 | — | 60 |
| | (Lotader 5500) | | (of which 30% |
| | | | prepolymer and |
| | | | 30% high mass) |
| 5 | 30 | — | 70 |
| | (15% Lotader | | (of which 30% |
| | 5500 + 15% | | prepolymer and |
| | Lotader 4210) | | 40% high mass) |
| 6 | 5 | 31 | 64 |
| | | | (of which 24% |
| | | | prepolymer and |
| | | | 40% high mass) |
| 7 | 31 | 5 | 64 |
| | | | (of which 24% |
| | | | prepolymer and |
| | | | 40% high mass) |
| 8 | 14 | 16 | 70 |
| | | | (of which 30% |
| | | | prepolymer and |
| | | | 40% high mass) |
| 9 | 28 | 12 | 60 |
| | | | (of which 30% |
| | | | prepolymer and |
| | | | 30% high mass) |
| 10 | 20 | 20 | 60 |
| | | | (of which 10% |
| | | | prepolymer and |
| | | | 50% high mass) |
| 11 | 18 | 12 | 60 |
| | | | (of which 15% |
| | | | prepolymer and |
| | | | 45% high mass) |
| 12 | 15 | 20 | 65 |
| | | | (of which 5% |
| | | | prepolymer and |
| | | | 60% high mass) |
| 13 | 15 | 20 | 65 |
| | | | (of which 35% |
| | | | prepolymer and |
| | | | 30% high mass) |
| 14 | 12 | 13 | 75 |
| | | | (of which 35% |
| | | | prepolymer and |
| | | | 40% high mass) |
| 15 | 25 | 28 | 47 |
| | | | (of which 20% |
| | | | prepolymer and |
| | | | 27% high mass) |
| 16 | 25 | 26 | 49 |
| | | | (of which 27% |
| | | | prepolymer and |
| | | | 22% high mass) |
| 17 | 36 | 16 | 48 |
| | | | (of which 25% |
| | | | prepolymer and |
| | | | 27% high mass) |
| 18 | 15 | 36 | 48 |
| | | | (of which 25% |
| | | | prepolymer and |
| | | | 27% high mass) |

The synthesis, by the reactive extrusion process, of the materials of each composition was carried out on a co-rotating twin-screw extruder of Werner type, with a 40 mm (millimeter) diameter and a length 40 times its diameter, with a flat profile at 260° C., a throughput of 70 kg/h (kilograms per hour) and a rotational speed of 300 rpm (revolutions per minute). The materials are introduced into the main feed.

Tests Carried Out on the Test Specimens:

Two types of tests were mainly carried out on compositions 1 to 18 in order to test for potential resolution of the abovementioned technical problems; it should however be noted that the compositions according to the invention moreover have other particularly advantageous properties which have not been the subject of tests here.

These two tests consist on the one hand of measuring the flexural modulus at 23° C., expressed in megapascal (MPa), and on the other hand of measuring the resilience at −20° C., expressed in kilojoules per square meter (kJ/m²).

Test of the “Flexural Modulus at 23° C.”:

The flexural modulus was measured on a Zwick dynamometer according to ISO 178 standard. The measurements were carried out at 23° C. on samples conditioned for 14 days at 23° C. at a degree of humidity of 50%.

Notched Charpy Impact Test at −20° C.:

The Charpy impact tests were carried out on a Zwick pendulum according to ISO 179 eA. The test specimens were notched in a V to 2 mm. The measurements were carried out at −20° C. on samples conditioned for 14 days at 23° C. at a degree of humidity of 50%.

For these two mechanical tests, ISO 1A test specimens and bars of dimensions 80×10×4 mm³ were produced by injection molding on a Krauss Maffei injection press. The following process parameters were used:
Injection temperature (supply/nozzle): 240/260° C.
Mold temperature: 40° C.
Hold time: 10 seconds
Material hold pressure: 900 bar
Cooling time: 12 seconds

The results for each composition are reproduced in the table below.

| | Results of the modulus of elasticity |
|---|---|
| Composition no. | test at 23° C. (MPa) |
| 1 | <200 |
| 2 | 520 |
| 3 | 690 |
| 4 | 490 |
| 5 | 520 |
| 6 | 330 |
| 7 | 490 |
| 8 | 400 |
| 9 | 460 |
| 10 | 460 |
| 11 | 500 |
| 12 | 620 |
| 13 | 500 |
| 14 | 440 |
| 15 | 220 |
| 16 | 230 |
| 17 | 320 |
| 18 | 240 |

Resilience Test at −20° C.:

The resilience test at −20° C. consists of a test of impact bending on a notched Charpy test specimen. This test is carried out according to international standard ISO 179-1, each test specimen (of one of the abovementioned compositions) consisting of a bar which has been notched in the center thereof by machining. The shape of notch most commonly used is the shape of a V with a depth of 2 mm. The results for each composition are reproduced in the table below.

| | Results of the resilience |
|---|---|
| Composition no. | test at −20° C. (kJ/m²) |
| 1 | >50 |
| 2 | 15 |
| 3 | 12 |
| 4 | 14 |
| 5 | 15 |
| 6 | 49 |
| 7 | 15 |
| 8 | 33 |
| 9 | 37 |
| 10 | 84 |
| 11 | 81 |
| 12 | 70 |
| 13 | 84 |
| 14 | 75 |
| 15 | 67 |
| 16 | 66 |
| 17 | 74 |
| 18 | 72 |
| 18 | 85 |

The results for the two tests carried out on each of the compositions clearly demonstrate on the one hand the technical advantages of the composition according to the invention even though these advantages can in no way be predicted, and on the other hand the preferred ranges (% by weight) for this composition. For ease of reading, the compositions according to the present invention, namely compositions no. 8 to no. 14, and their results from the two tests, are given in bold.

It will be noted that the second copolymer is chosen, in the examples of composition according to the invention, to be of a single type, namely a maleicized ethylene-propylene copolymer, but is has been demonstrated that the other copolymers listed as possible copolymer (maleicized ethylene-butene copolymer, maleicized ethylene-hexene copolymer, maleicized ethylene-octene copolymer, maleicized ethylene-methylacrylate copolymer, ethylene-propylene-diene copolymer) would give results which are similar or very close to those observed for the compositions containing the copolymer presented in the examples.

1-11. (canceled)

12. A thermoplastic composition comprising:
a first copolymer grafted by polyamide grafts, the first copolymer having a polyolefin backbone and a plurality of polyamide grafts,
wherein the polyolefin backbone contains a residue of at least one unsaturated monomer (X),
wherein the polyamide grafts are attached to the polyolefin backbone by the residue of the unsaturated monomer (X) comprising a function capable of reacting by a condensation reaction with a polyamide having at least one amine end group and/or at least one carboxylic acid end group,
wherein the residue of the unsaturated monomer (X) is fixed to the backbone by grafting or copolymerization;
a second copolymer, distinct from the first copolymer, being an elastomeric copolymer grafted by polyamide grafts, the second copolymer having a polyolefin backbone and a plurality of polyamide grafts,
wherein the polyolefin backbone is selected from the group consisting of a maleated ethylene-propylene copolymer, a maleated ethylene-butene copolymer, a maleated ethylene-hexene copolymer, a maleated ethylene-octene copolymer, a maleated ethylene-methyl acrylate copolymer, and a maleated ethylene-propylene-diene copolymer;
a third component selected from the group consisting of a polyamide, a polyethylene or a polypropylene, or a mixture thereof, wherein the polyethylene is selected from VLDPE, LDPE, LLDPE, MDPE, and HDPE;
wherein, the following weight ratios are satisfied:
between 10% and 30% by weight of the composition for the polyolefin backbone of the first copolymer,
between 10% and 30% by weight of the composition for the polyolefin backbone of the second copolymer,
between 5% and 35% by weight of the composition of polyamide grafts of the first and second copolymer,
between 30% and 60% by weight of the third component.

13. The composition as claimed in claim 12, wherein the third component is a polyamide or a polypropylene.

14. The composition as claimed in claim 12, wherein the third component is a polyamide.

15. The composition as claimed in claim 12, wherein the third component is a polypropylene.

16. The composition as claimed in claim 12, wherein the third component is the polyethylene selected from VLDPE, LDPE, LLDPE, MDPE, and HDPE.

17. The composition as claimed in claim 16, wherein the polyethylene is a high molecular weight polyamide.

18. The composition as claimed in claim 12, wherein the unsaturated monomer (X) is maleic anhydride.

19. The composition as claimed in claim 18, wherein the first copolymer is an ethylene/alkyl (meth)acrylate/maleic anhydride terpolymer.

20. The composition as claimed in claim 12, wherein the first copolymer is nanostructured and the second copolymer is nanostructured.

21. The composition as claimed in claim 12, where the number-average molar mass of the polyamide grafts of the first copolymer is within the range from 1000 to 10,000 g/mol, and the number-average molar mass of the polyamide grafts of the second copolymer is within the range from 1000 to 10,000 g/mol.

22. The composition as claimed in claim 12, wherein the polyamide grafts of the first copolymer and of the second copolymer consist of monofunctional-NH₂-terminated polyamide PA-6 grafts.

23. The composition as claimed in claim 22, wherein the polyamide of the third component is selected from the group consisting of a polyamide 6, a polyamide 11, polyamide 12, polyamide 6,6, polyamide 6,9, polyamide 6,10, polyamide 6,12, polyamide 10,12, polyamide 10,10, polyamide 12,12, semiarometic polyamide, polyphthalamides obtained from terephthalic and/or isophthalic acid, and their copolyamides.

24. The composition as claimed in claim 12, wherein the first copolymer and the second copolymer represent a maximum of 50% by weight of the composition.

25. The composition as claimed in claim 12, wherein the composition additionally comprises a plasticizer, an adhesion promoter, a UV stabilizer and/or a UV absorber, an antioxidant, a flame retardant, and/or a dyeing/whitening agent.

26. The composition as claimed in claim 12, wherein the composition consists of the first copolymer, the second copolymer, and the third component.

27. A thermoplastic composition comprising:
a first copolymer grafted by polyamide grafts, the first copolymer having a polyolefin backbone and a plurality of polyamide grafts,
wherein the polyolefin backbone contains a residue of at least one unsaturated monomer (X),
wherein the polyamide grafts are attached to the polyolefin backbone by the residue of the unsaturated monomer (X) comprising a function capable of reacting by a condensation reaction with a polyamide having at least one amine end group and/or at least one carboxylic acid end group,
wherein the residue of the unsaturated monomer (X) is fixed to the backbone by grafting or copolymerization;
a second copolymer, distinct from the first copolymer, being an elastomeric copolymer grafted by polyamide grafts, the second copolymer having a polyolefin backbone and a plurality of polyamide grafts,
wherein the polyolefin backbone is selected from the group consisting of a maleated ethylene-propylene copolymer, a maleated ethylene-butene copolymer, a maleated ethylene-hexene copolymer, a maleated ethylene-octene copolymer, a maleated ethylene-methyl acrylate copolymer, and a maleated ethylene-propylene-diene copolymer;
a third component being a high molecular weight polyethylene;
wherein, the following weight ratios are satisfied:
between 10% and 30% by weight of the composition for the polyolefin backbone of the first copolymer,
between 10% and 30% by weight of the composition for the polyolefin backbone of the second copolymer,
between 5% and 35% by weight of the composition of polyamide grafts of the first and second copolymer,
between 30% and 60% by weight of the third component.

28. A multilayer structure comprising a plurality of adjacent layers, wherein at least one of these layers consists of the composition as defined in claim 12.
